(19) United States
(12) Patent Application Publication
(10) Pub. No.: US 2026/0075457 A1
(43) Pub. Date: Mar. 12, 2026

(54) TRAFFIC OFFLOADING SOLUTION BASED ON POWER SAVINGS OVER 5G NON-TERRESTRIAL-NETWORK

(71) Applicants: AT&T Intellectual Property I, L.P., Atlanta, GA (US); AT&T Technical Services Company, Inc., Vienna, VA (US)

(72) Inventors: Daniel Vivanco, Ashburn, VA (US); David Ross Beppler, Duluth, GA (US); Thomas W. Henderson, Alpharetta, GA (US)

(73) Assignees: AT&T Intellectual Property I, L.P., Atlanta, GA (US); AT&T Technical Services Company, Inc., Vienna, VA (US)

(21) Appl. No.: 18/830,936

(22) Filed: Sep. 11, 2024

(51) Int. Cl. H04W 28/02; H04B 7/185; H04W 52/02

(52) U.S. Cl. CPC H04W 28/0268; H04B 7/18515; H04W 52/0274

(57) ABSTRACT

Aspects of the subject disclosure may include, for example, receiving packets at a network element associated with a non-terrestrial communications network, classifying the packets according to a performance criterion, forming classified packets, detecting occurrence of a predetermined transmission condition, transmitting the classified packets to a satellite for retransmission from the satellite to a terrestrial user equipment, and disabling a high-power amplifier (HPA) of the satellite following the transmitting the classified packets to the satellite to reduce power consumption in the satellite. Other embodiments are disclosed.

### FIELD OF THE DISCLOSURE

The subject disclosure relates to traffic management techniques for multi-carrier communication systems combining terrestrial cellular networks and non-terrestrial satellite networks (NTN).

### BACKGROUND

Wireless operators may use multi-carrier fifth generation cellular (5G) non-terrestrial network (NTN) satellite cells to provide wireless communication capacity and coverage to terrestrial user equipment (UEs). These carriers may use the same frequency band (intra-band) or different frequency band (inter-band). Each carrier may have different power saving goals and constraints. In addition, terrestrial UE traffic also may have different traffic profiles.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B illustrates micro-discontinuous transmission μDTX in a radio network in accordance with various aspects described herein.

FIG. 2C depicts an illustrative embodiment of a method in accordance with various aspects described herein.

FIG. 2D is a block diagram illustrating an example, non-limiting embodiment of a system functioning within the communication network of FIG. 1 in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for using micro-discontinuous transmission (μDTX) to reduce power consumption in satellites of a non-terrestrial network that provides communication services to terrestrial user equipment. Information such as packets intended for a user device are received and classified. Classification information is used to collect packets having similar delay characteristics in common and transmit the collected packets to the satellite from a ground station for relay to the user device. Using this infrequent, discontinuous transmission, high-power components of the satellite may be energized only when needed, thereby saving satellite power. Other embodiments are described in the subject disclosure.

One or more aspects of the subject disclosure include receiving packets at a network element associated with a non-terrestrial communications network, classifying the packets according to a performance criterion, forming classified packets, detecting occurrence of a predetermined transmission condition, transmitting the classified packets to a satellite for retransmission from the satellite to a terrestrial user equipment, and disabling a high-power amplifier (HPA) of the satellite following the transmitting the classified packets to the satellite to reduce power consumption in the satellite.

One or more aspects of the subject disclosure include switching a high-power amplifier (HPA) of a satellite to a low power state to conserve power at the satellite, wherein the switching comprises transmitting a command from a gateway to the satellite, the satellite operative for communication with terrestrial user equipment, receiving packets at the gateway, wherein the receiving the packets comprises receiving data intended for communication to the terrestrial user equipment, classifying the packets according to delay requirements for respective packets, wherein packets having similar delay requirements are classified together, forming groups of classified packets, detecting an occurrence of a predetermined transmission condition for the satellite, switching the HPA of the satellite to an operating power state to enable full radio operation of the satellite, transmitting the groups of classified packets to the satellite for retransmission from the satellite to the terrestrial user equipment, wherein the transmitting the groups of classified packets is according to delay requirements of packet of the groups of classified packets, and after the transmitting the groups of classified packets, switching the HPA of the satellite to the low power state to conserve power at the satellite.

One or more aspects of the subject disclosure include receiving, by a processing system including a processor, packets at a network element associated with a non-terrestrial communications network, the packets for communication to respective terrestrial user equipment by a satellite, the satellite employing multiple respective carriers for radio communication with terrestrial user equipment, each respective carrier of the multiple respective carriers being communicated using a respective high power amplifier (HPA), each respective HPA being maintained in an OFF state when not used for communication, classifying, by the processing system, the packets according to delay requirements for respective packets, wherein packets having similar delay requirements are classified together, forming groups of classified packets, selecting, by the processing system, a respective carrier of the multiple respective carriers for communicating a group of classified packets, forming a selected carrier, switching the respective HPA of the satellite associated with the selected carrier to an ON state to enable radio communication by the selected carrier, transmitting the group of classified packets to the satellite for retransmission from the satellite to the terrestrial user equipment on the selected carrier, and after the transmitting the group of classified packets, switching the respective HPA of the satellite to the OFF state to conserve power at the satellite.

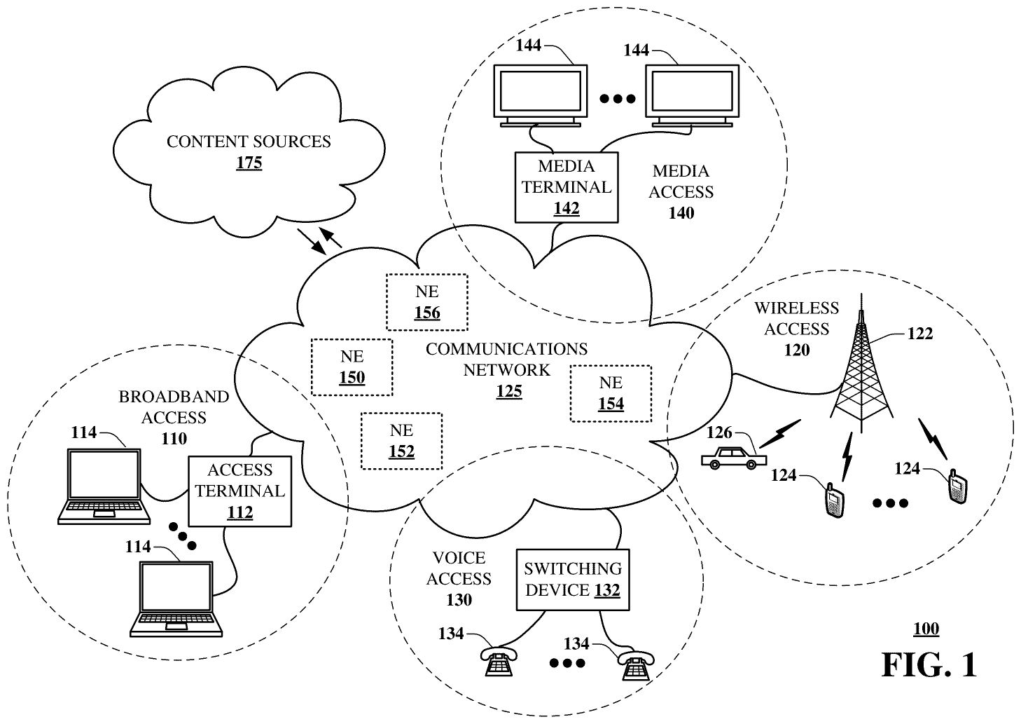

Referring now to FIG. 1, a block diagram is shown illustrating an example, non-limiting embodiment of a system 100 in accordance with various aspects described herein. For example, system 100 can facilitate in whole or in part using micro-discontinuous transmission (μDTX) to reduce power consumption in satellites of a non-terrestrial network that provides communication services to terrestrial user equipment by categorizing packets prior to transmission and transmitting only packets with similar delay requirements at a selected time. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or another switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

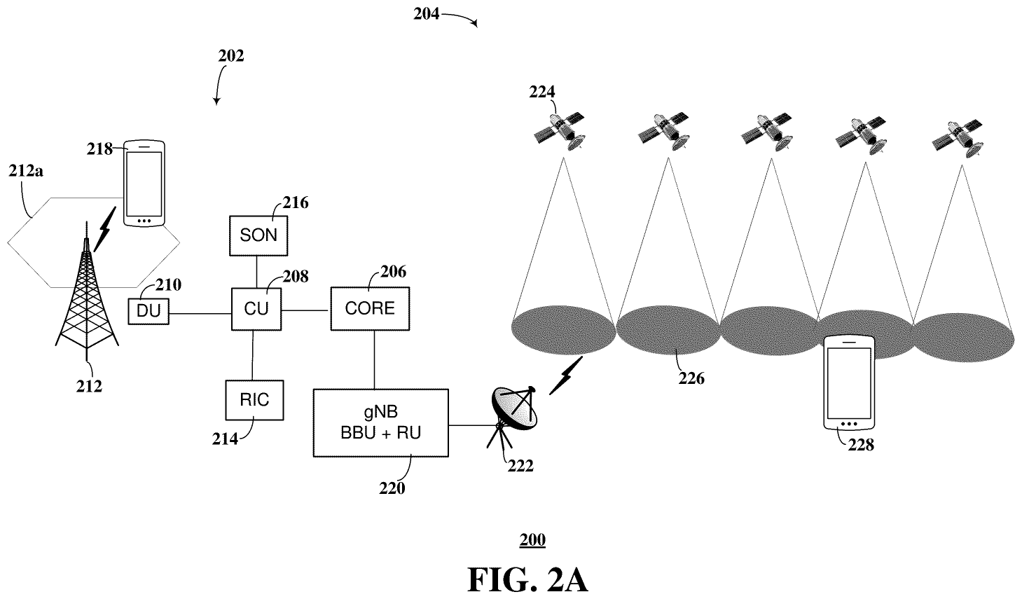

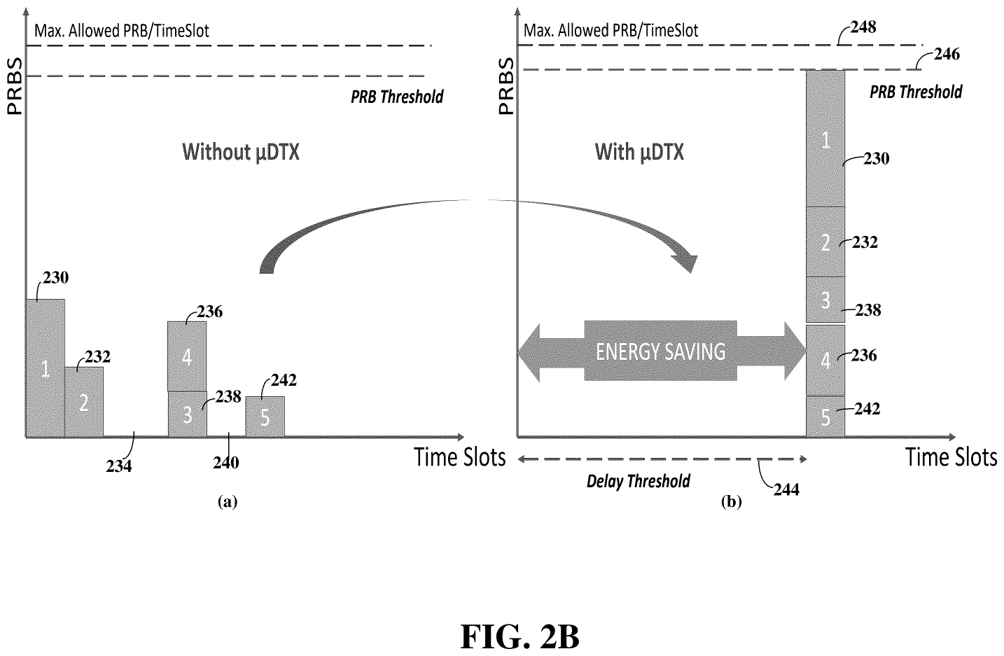

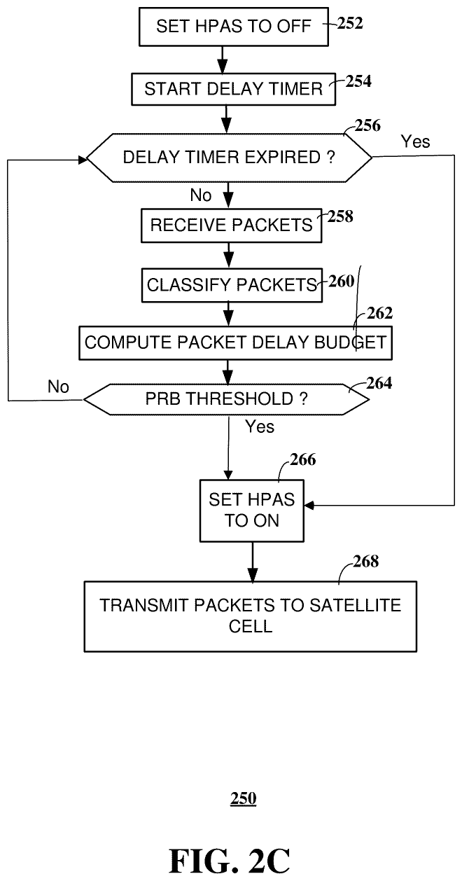

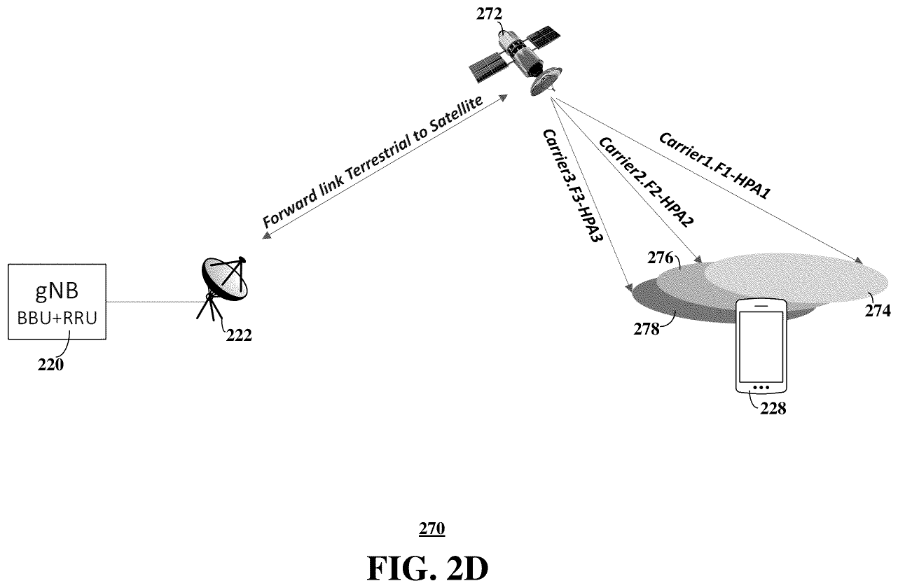

FIG. 2A is a block diagram illustrating an example, non-limiting embodiment of a system 200 functioning within the communication network of FIG. 1 in accordance with various aspects described herein. The system 200 includes a cellular network 202 and a satellite network 204. The cellular network 202 may be termed a terrestrial network (TN). Similarly, the satellite network 204 may be termed a non-terrestrial network (NTN). In embodiments, the cellular network 202 may be owned and operated by a mobile network operator (MNO), also referred to as a cellular service provider (CSP). The CSP may also operate the satellite network 204 or may partner with a separate organization operating the satellite network 204. The cellular network 202 and the satellite network 204 may cooperate to provide communication services to the same group of users.

The cellular network 202 in the exemplary embodiment includes a core network 206, one or more centralized units such as centralized unit (CU) 208, one or more distributed units such as distributed unit (DU) 210, one or more radio units (RU) 212, a radio access network (RAN) intelligent controller (RIC) 214, and a self-organizing network (SON) 216. Other embodiments of cellular networks will have additional or alternative components.

The core network 206 provides a variety of centralized functions for the cellular network 202. Such functions may include mobility management, accounting and authorization and others. Further, the core network 206 may include one or more gateways to other networks such as the public internet.

The CU 208 handles control plane functions of the cellular network 202. These functions may include user session management, resource allocation, mobility management and others. The CU 208 communicates with the core network 206 and distributed units such as DU 210 to exchange information to manage radio resources and user sessions.

The DU 210 handles user plane functions of the cellular network 202 including processing data traffic and managing radio resources. The DU 210 manages radio resources such as the RU 212. The DU 210 operates as a baseband unit (BBU) to process baseband communication signals between the RU 212 and the CU 208, including both uplink (UL) and downlink (DL) signals. The uplink is the radio connection from the UE 218 to the RU 212; the downlink is the radio connection from the RU 212 to the UE 218. The DU 210 in combination with one or more RUs such as RU 212 establishes a radio access network for access by a subscriber unit or user equipment (UE) such as UE 218. The RU 212 provides communications services to a coverage area 212a near the RU 212 for UEs such as the UE 218 in the coverage area 212a.

The RU 212 is in radio communication with radio devices such as UE 218, other user equipment, internet of things (IoT) devices, and others. The RU 212 may include or be part of an eNodeB in a fourth generation (4G, or long-term evolution, LTE) cellular network or a gNodeB in a 5G or later cellular network. The RU 212 operates according to an air interface standard such the standards published by the 3^{rd} Generation Partnership Project (3GPP; 3GPP is a registered trademark of the European Telecommunication Standards Institute). User devices such as UE 218 may attach to the cellular network 202 by initiating communication with the RU 212. The RU 212 and similar RUs provide user mobility by handing off radio communications with the UE 218 from the RU 212 to another RU in the cellular network.

The RIC 214 manages and optimizes various function for the RAN. The RIC 214 may be divided into real-time and near-real-time functions. The non-real-time RIC is part of the CSP's service management and orchestration (SMO) framework. In this role, the non-real-time RIC enables control of RAN elements and their resources. The near-real-time RIC enables actions and functions in the RAN that take 10 ms to 1 second to complete.

The SON 216 cooperates with other components of the cellular network 202 to improve network performance. In one example, the SON 216 operates to adjust radio frequencies used by different network elements to minimize interference, improve coverage and network capacity. In some embodiments, the SON 216 implements artificial intelligence (AI) or machine learning (ML) processes to manage network operation based on collected data about the network and network operation.

The UE 218 may be any mobile or portable radio device or IoT device capable of communicating with the cellular network. In general, the UE communicates on one or more frequency bands and operates under control of the cellular network. The cellular network 202 may be a fifth generation (5G) cellular network or later modification or enhancement, such as a sixth generation (6G) cellular network. The UE 218 may communicate with the 5G, 6G and other network technologies.

The cellular network 202 may cooperate with the satellite network 204 to provide communication services to UEs such as the UE 218 and UE 228. The satellite network 204 includes terrestrial equipment such as gateway 220 and one or more ground stations such as ground station 222, along with one or more satellites 224. Other embodiments of the cellular network 204 may include additional or alternative elements and functions. The embodiment of FIG. 2A is intended to be exemplary only.

The gateway 220 in the illustrated example is in data communication with the core network 206 of the cellular network 202. The ground equipment provides many of the same functions as CU 208, DU 210, RU 212, RIC 214 and SON 216. The gateway 220 may include or provide functions of a gNodeB or gNB as well as a baseband unit (BBU) and RU in a terrestrial network such as cellular network 202.

The gateway 220 is in in data communication with ground station 202. The ground station 202 communicates via radio signals with Earth orbiting satellites such as satellites 224. In turn, the satellites 224 communicate with one or more UEs such as UE 228.

The satellites 224 are in generally low Earth orbit. Typical altitude for the satellites 224 is 500 to 700 km. In some embodiments, the satellites 224 travel in a cluster or constellation of more than one satellite. The satellites 224 provide communication services to a service area 226 on the surface of the earth. In the example, the service area 226 for each satellite is illustrated as being generally round in shape. However, the service area may have any suitable shape or configuration depending on terrain, angle of arrival at the earth's surface and conditioning or shaping of the transmitted beam or received beam at the satellites 224.

A cellular service provider with a terrestrial cellular network (TN) such as the cellular network 202 may own or cooperate with a direct cellular-to-satellite non-terrestrial network such as the satellite network 204 in addition to the terrestrial network. A cellular-to-satellite non-terrestrial network (NTN) can create a direct connection from a conventional cellular telephone of a customer or subscriber using LTE, 5G, GSM, UMTS, 6G, or other commercially available cellular technology User Equipment (UE) to a satellite such as satellite 224. The satellite must use frequency bands that the UE is already designed to communicate with and must use either unlicensed bands or bands that are licensed to the CSP.

Satellite cells or coverage areas such as service area 226 may be used to provide additional coverage or capacity to terrestrial cells such as coverage area 212a. Satellite cells may have the ability to use one or more cells, and to operate at different frequency bands (i.e. band B5, in the 850 MHz band, and band B14 in the 1700 MHz band). The CSP or wireless operator may have the ability to mandate satellite cells to change frequency bands to avoid interference with terrestrial cells, which may operate in the same frequency band. Thus, the CSP operating the cellular network 202 may manage radio resources of the satellite network 204 to provide reliable communications services.

In other examples, the CSP can use satellite cells to provide additional service capacity to specific areas at specific hours of the day. An example is the busy hour, or the time in the day when the cellular network experiences heaviest traffic loading. Also, the CSP may have the ability to change the coverage area of the satellite cells or schedule the coverage of the satellite cells in such a way that satellite cells or service areas 226 of the satellite network 204 serve the congested terrestrial RAN areas at their corresponding busy times to supplement coverage provided by the cellular network 202.

The CSP may be generally aware of the time and duration when the satellite cells or service areas 226 will cover or coincide with congested areas of the cellular network 202. The CSP or wireless operator is also aware of the frequency bands used in the terrestrial cells, and also is also aware of the capabilities of IoT devices and UEs such as UE 218 and bands that these devices support. The CSP may use different frequency bands in different locations. Frequency bands are generally licensed by the CSP from an authority such as the US government. Other authorities in other jurisdictions may license other bands for use by the CSP.

As illustrated in the example of FIG. 2A, the operator of the satellite network 204 may deploy several satellites in a batch or constellation. In the example of FIG. 2A, a constellation of satellites 224 includes five satellites travelling together in low earth orbit. Each satellite provides two-way communication services to a service area or satellite cell. Each satellite cell may have a predefined coverage area such as service area 226. In an example, the coverage area is generally round in shape with a radius on the Earth's surface of approximately 50 km. Satellite cells or coverage areas or service areas may be arranged in a specific formation to provide continuous coverage to terrestrial UEs. For example, if the satellites 224 in FIG. 2A are in low Earth orbit and moving from left to right in the drawing figure, the coverage area including the five contiguous service areas 226 moves from left to right as well. The service areas 226 may be linked to cooperate and provide cellular service to a UE such as UE 228, IoT devices and other devices. A constellation of satellite cells can provide larger continuous coverage based on the number of satellite cells in the group.

In general, each satellite of the satellites 224 includes solar arrays on one side and antenna elements on the other side. The solar array, when exposed to sunlight, convert sunlight into electricity to power the satellite. Electricity may be stored in a depletable source such as a battery, for example. The antenna elements direct a beam at a location on the Earth's surface to provide communication services. Providing that service requires expending energy by the satellite, both to communicate with the UE 228 on the ground and to communicate with the ground station 222 to connect to the mobile network operator's network.

Providing such communication services generally happens throughout the day, depending on the position of the satellite around the Earth. During daytime, when the antenna elements are pointed at the Earth, the back of the satellite including the solar arrays are pointed at the sun and can be active. The satellite can absorb light and create energy and direct energy to the ground. However, at nighttime, the satellite is on the dark side of the Earth and still has to expend energy toward the ground. But during that time, the solar arrays are pointed towards dark space, so the satellite has to run off battery power.

A low Earth orbit has an orbital period of about 90 minutes corresponding to about 45 minutes in the light and 45 minutes in the dark. If the satellite has a high duty cycle broadcasting radio power to the Earth, the gathering and storing of energy on the light side of the Earth becomes critical. Similarly, conserving energy on the dark side of the Earth is equally critical.

In general, a base station unit including an eNB or gNB consists of a radio unit and a power amplifier (PA), also referred to as a high-power amplifier or HPA. The radio unit is responsible for generating and decoding the waveform. The HPA is responsible for amplifying the power of the transmit waveform. Power consumption in a PA depends on the desired coverage. It should be noted that an eNB or gNB can use a PA on both transmit side and the receive side. In the present description, only the case of HPA in the transmit side is considered.

Some communication systems implement discontinuous transmission. Discontinuous transmission or DTX is a technique use particularly in voice communications for conserving bandwidth by transmitting data only when necessary. A DTX system continuously monitors an audio signal such as input speech for periods of silence or low-level noise. When the DTX system detects silence, it pauses the transmission of data so that no data is sent over the network during these periods. When speech or other audio input resumes, the DTX system resumes transmission of data. Thus, DTX reduces the amount of bandwidth required for voice communication. Also, for devices with limited battery power, DTX can help extend battery life by reducing the amount of time the transmitter is active.

In embodiments, the system 200 of FIG. 2A may implement micro discontinuous transmission (μDTX or Micro-DTX) as an energy efficiency tool. This particularly applies to an Orthogonal Frequency Division Multiple Access (OFDMA) system. Such a system uses multiple orthogonal subcarriers, each carrying a separate data stream. In a μDTX implementation, a radio unit may turn-off PA paths autonomously, per OFDMA symbol, when there is no data to transmit.

In general, a mobile network operator have both the radio unit and the PA of a gNB powered on, regardless if there is data to transmit or not. In an idle period, even though no data is transmitted, the PA is still energized and consumes energy. According to the μDTX feature the gNB downlink (DL) packet scheduler buffers small, non-delay sensitive packets into bigger chunks of data to be sent less frequently. This increases the utilization of Micro-DTX. Some packets are identified as delay sensitive, such as packets intended for a first responder engaged in emergency service. Such delay sensitive data packets are still transmitted as soon as possible according to the scheduler. Benefits of v μDTX include reduced gNB energy consumption.

A key goal of μDTX \s to reduce energy consumption, while maximizing full cell bandwidth instead of low cell utilization, also while delivering small data chunks. One challenge for using μDTX is that the numerous small packets and channels may occupy a large part of transmission time even if user plane data volumes are low or medium. This depends on factors such as data traffic patterns. μDTX needs to detect and predict idle periods in which the Radio Unit (RU) can switch off the PA. μDTX improves energy savings by buffering small, non-delay-sensitive packets into bigger chunks of data to be sent more rarely or less frequently, which extends Idle Periods, triggering μDTX more often.

FIG. 2B illustrates micro-discontinuous transmission (μDTX) in a radio network in accordance with various aspects described herein. FIG. 2B illustrates operation of a radio transmitter for transmission of physical resource blocks (PRBs) in a radio system on the vertical axis versus time slots on the horizontal axis. FIG. 2B(a) illustrates operation without the use of μDTX. As PRB information is received at the transmitter, the PRB information is transmitted immediately as received. Thus, a first PRB 230 is transmitted during a first time slot. A second PRB 232 is transmitted during a second time slot immediately following the first time slot. Then a gap 234 occurs when no PRBs are available for transmission. After that, two PRBs including third PRB 236 and fourth PRB 238 are available and are transmitted. Another gap 240 follows with no data for transmission, followed by a fifth PRB 242 which is immediately transmitted.

In a conventional system, without using μDTX, the transmitter including a radio unit and PA remains fully energized the entire time duration. This includes time such as gap 234 and gap 240 when there is no data available for transmission. With the radio circuits energized, power dissipation is relatively high. In a battery powered radio, the battery may be depleted relatively rapidly and result in failure or other unavailability until the batter can be recharged.

FIG. 2B(b) illustrates similar operation in a system using μDTX. In the same way as illustrated in FIG. 2B(a), PRB information arrives in the same random way at the transmitter. However, in the μDTX system, portions of the transmitter, especially the high-power amplifier, remain turned off or de-energized. Information for transmission, such as the PRB information of first PRB 230, the second PRB 232, the third PRB 236, the fourth PRB 238 and the fifth PRB 240 are accumulated and stored in a buffer at the transmitter or other convenient network location. When a delay threshold 234 is reached, the set of PRBs or PRB information is all transmitted in a single time slot, or as many time slots are required to transmitted to accumulated information. Until the delay threshold 234 is reached, the high-power circuits such as the PA of the transmitter remain powered down and de-energized. This serves to reduce power consumption in the transmitter and to extend battery life. The longer the information for transmission is buffered, the greater the power savings.

The μDTX system may have limits for some types of data. For example, if the data is held or buffered for too long, the data may arrive at a receiver or other circuit on the other end of the channel at a time later than was expected. This may be problematic for data such as Voice over IP (VoIP) data, for example, which carries live speech that may seem corrupted by too much buffering. The acceptable delay for such data may only be one or two symbols. On the other hand, for hypertext transfer protocol (HTTP) data associated with a web browser or transfer of a data file, may be held a relatively long duration, thereby conserving substantial power at the transmitter.

However, in the embodiment of FIG. 2B, the μDTX system implements a PRB threshold 246 indicating a maximum number of PRBs or amount of transmission information that may be retained or buffered before a transmission of the retained information is triggered and the PA is powered up to transmit the information. The PRB threshold 246 may be selectively set based on any suitable factors. The PRB threshold 246 should be set at a level below a maximum allowed PRB per time slot value 248 for the radio transmission system. In one example, the PRB threshold 246 may be set at 80% of the maximum allowed PRB per time slot value 248. The maximum allowed PRB per time slot value 248 may be set by, for example, physical limits on how many packets may be transmitted in a fixed amount of time or may be set by a system design guideline such as peak-to-average-power-ratio (PAPR). For example, in a transmitter, when the PA is driven into its non-linear region due to high PAPR, the Pa becomes less efficient, leading to increased power consumption and reduced battery life. The PRB threshold 246 should be set at a value to reduce or eliminate factors such as PAPR.

A terrestrial network such as cellular network 202 may establish discontinuous transmission for some or all of the terrestrial network. The network conditions change only slightly over time. A rural portion of the network, with relatively little traffic, may make substantial user of μDTX to reduce power consumption and conserve bandwidth in that network portion. A portion of the network with heavier traffic volume, or more high-priority traffic such as VoIP calls, may be set up with a relatively low usage of μDTX.

On the other hand, for a non-terrestrial network such as satellite network, the usage profile and traffic profile are constantly changing. At some times, the satellite is over and serving rural areas with low traffic volume and relatively low priority traffic. At other times, the satellite is over and serving areas with heavy traffic and higher-priority traffic. Changes from one type of traffic to another can occur rapidly because the orbital period for a satellite is on the order of 90 minutes.

Accordingly, the use of μDTX should be elastic. Such elasticity allows the system and method to maintain higher power savings while maintaining application QoS requirements. Moreover, that elasticity depends on many conditions. For example, in embodiments, the system and apparatus has knowledge of 5G-NTN cell constellation configurations and conditions. For example, the satellites may be combined in a constellation of 5 satellites as shown in FIG. 2A. In other cases, satellites may operate solo, in bigger or smaller constellations. Further, as noted, the conditions for operation of the satellites vary rapidly, from high-traffic areas to low-traffic areas in just a matter of minutes. In other examples, the system and method have information about approximate cell coverage areas and duration. For example, the coverage duration in an area may be as little as 2-3 minutes or as much as 10-20 minutes. In other examples, the system and method employs a mix of relaxed and stringent μDTX thresholds for cells in the same 5G-NTN constellation. Threshold selection may be based on density and sized of the 5G-NTN constellation and an expected coverage duration.

In other examples, the use of μDTX may depend on what type of traffic is passing through network elements at a particular time. In general, traffic is received and processed as packets, each packet having a header and a payload. The header includes addressing and control information. The payload includes the data of interest to a user. The system and method may operate to perform a packet classification on each packet. Packet classification operates to identify an application type and to infer packet delay requirements.

In some embodiments, classification can be done by means of Deep Packet Inspection (DPI) techniques. DPI involves examining the data contained within individual packets to identify and classify various types of traffic, such as web browsing traffic, video streaming traffic, VoIP traffic, and more. DPI can accurately categorize different types of traffic based on their characteristics, such as protocols, port numbers, and payload content. DPI can identify specific applications or services being used by subscribers, enabling network operators to optimize resource allocation and provide targeted services. Thus, DPI can identify the application type associated with a packet (such as HTTP or P2P) and infer the corresponding delay requirements.

In one example, IP packet priority is marked in the IP-Packet header with a Differentiated Services Code Point (DSCP) code. DSCP is a mechanism used to classify and manage network traffic, providing Quality of Service (QoS) information in modern IP networks, including cellular networks. DSCP uses a 6-bit field in the IP header for packet classification. IP Packets determined to have a high priority based on their DSCP are then mapped to high priority Quality of Service Class Identifier (QCI). QCI is a parameter used in cellular networks to classify different types of data traffic. For example, traffic associated with first responders is given a predefined QCI value and that QCI value indicates a high priority for handling in a cellular network. Similarly, buffered, streaming video data is assigned a different QCI value which is associated with a different, lower priority. IP packets determined to have a high priority based on the DSCP value of the packet may then be mapped to a high priority RU-QCI. The gateway 220 may include functionality of an eNB scheduler which can use the packet QCI marking to classify packets by priority and decide to either hold them or deliver them right away, while μDTX mode is activated in the eNB.

As noted above, the delay threshold is one variable parameter controlling μDTX operation. Delays may be relaxed or constrained depending on the type of traffic being processed through network elements. In some embodiments, a Packet Delay Budget (PDB) for a corresponding packet can be estimated based on a traffic profile. For example, VoIP traffic may have a smaller PDB than HTTP traffic. In some examples, the PDB may come from pre-established tables for selection based on traffic type and other conditions.

In another example, packets arriving at terrestrial gNB gateway such as the gateway 220 in FIG. 2A may be time stamped and queued in a buffer for transmission to satellite cell, such as the satellites 224 in a constellation. For each packet in the queue, the packet delay is computed. PDB may be computed as the time difference between the current time and the arrival time of the packet at the UE. The PDB gives an indication of how long a packet may be held in the queue before transmission from the gateway up to a satellite then back down to a UE for delivery. If the PDB is too long, the packet may arrive too late and be considered lost or may be discarded by the UE. That may trigger a retransmission which is very wasteful of network resources.

In an example, assume that a gNodeB computes the remaining time of the packet delay to approach the PDB, as follows:

dᵢ(t)=PBDᵢ−W_{i,t}

where PBDᵢ is the PDB of packet i and W_{i,t} t is the packet delay of packet i at time t. Thus, dᵢ(t) is the remaining time of the packet delay to approach its PDB.

The system and method thus operate to compare an expected packet delay with a delay threshold for the type of traffic. If the expected packet delay can be allowed for the queue for the type or traffic, then the packet may continue to be held. If the expected packet delay cannot be allowed, then the packet should be transmitted.

In embodiments, the operations of the system and method may be performed in any suitable network element. One suitable location is the gateway 220 (FIG. 2A), which has access to all required information and may have sufficient processing power to perform the required functions. In another example, the system and method may be located at the RIC 214 and included among near-real-time operations of the RIC 214 because the functions deal with scheduling. In particular, the gateway 220 knows the amount of data being buffered, numbers of packets and types of traffic. Further, the gateway 220 has information about the time delay required for transmission from the ground station 222 to the satellite and from the satellite back to the UE 228.

Some packets are given a high priority in the system 200. For example, Quality of Service (QoS) in a cellular network refers to the level of performance and reliability that a service provider can guarantee to its customers. QoS ensures that different types of data traffic, such as voice calls, video streaming, and data downloads, receive the appropriate level of service. Relatedly, the Quality of Service Class Identifier (QCI) is a parameter used in cellular networks to classify different types of data traffic and allocate resources accordingly. QCI provides a mechanism for prioritizing and differentiating various services based on their specific QoS requirements. QCI assigns a numerical value to each type of traffic. For example, traffic for first responders and emergency personnel may be given a highest priority for communication.

The system and method may respond in any suitable manner to such prioritization. In one example, the μDTX system may shorten the delay threshold or make the delay threshold more stringent for high priority traffic. In another example, the μDTX may change these the size of the buffer for a voice call with high priority.

In embodiments, in the μDTX system and method, packets may be classified and buffered at a terrestrial gNB gateway such as gateway 220. Packets are then transmitted to a satellite cell in a cluster. In general, the μDTX system and method will compute dᵢ and PBDᵢ for each packet that arrives at terrestrial gNB gateway. As noted, PBDᵢ should also take into consideration the delay of transmitting the data packet from terrestrial gNB gateway to satellite cell and from the satellite cell to terrestrial UEs. Those time delays may be considered constant. Data may be delivered from satellite cell to terrestrial UEs as soon as the data is received at the satellite cell.

During the OFF-Cycle, such as the time when a Delay_threshold timer has not yet expired, the terrestrial gNB Forward TX-HPA and Satellite RX-HPA are turned-OFF, therefore data cannot be transmitted. The gNB Forward TX-HPA corresponds to the high-power amplifier used at the gateway 220 for uplink transmission to the satellite. The Satellite RX-HPA corresponds to the high-power amplifier use for reception of the uplink at the satellite. In this example, a large Delay_threshold value implies that HPAs will be turned-OFF for a long period of time compared to a short Delay_threshold value. If a packet such as a VoIP packet with low PBD arrives at the terrestrial gNB gateway before the Delay_threshold timer has expired, this packet cannot be delivered until the Delay_threshold timer expires, and this may affect application QoS requirements.

In some embodiments, the μDTX system and method includes extra Information Element (IE) or parameter in a signalizing message for the BBU unit at the terrestrial gateway. The Information Element serves to communicate information about a power ON/OFF cycle to the satellite cell in real time. Any suitable combination of information may be included in the noted Information Element, such as a simple power ON and power OFF command or a command to set a power off duration for a specified number of seconds such as 20 seconds. The satellite cell responds by powering down its high-power amplifiers for transmitting and for receiving, thus reducing power consumption at the satellite during the specified duration.

In embodiments, the μDTX system and method provide an elastic μDTX mechanism over 5G-NTN networks. For example, that value for PRB_threshold and the value for Delay_threshold may vary dynamically in time depending on the traffic profiles, cell power saving goals, and 5G-NTN conditions. The terrestrial gNB gateway, gateway 220, may communicate the μDTX schedule to satellite cell in real-time while HPAs are Turned-ON (ON-Cycle). μDTX configuration can be updated on the next the ON-Cycle

FIG. 2C depicts an illustrative embodiment of a method 250 in accordance with various aspects described herein. The method 250 may be part of a solution for traffic management techniques over 5G multi-carrier Non-terrestrial Networks (NTN) or satellite networks when a micro-discontinuous transmit μDTX mechanism is enabled. The method 250 may help to preserve satellite cell power while maintaining user equipment (UE) QoS requirements. The method may be performed at any suitable network element of a telecommunications network such as a satellite gateway connecting a terrestrial network to one or more ground stations for the non-terrestrial network, or a radio access network intelligence controller (RIC) providing near-real-time processing of network operations. The method 250 may generally run autonomously to monitor traffic in the communications network and to manage power on (ON) and power off (OFF) conditions for one or more satellites of the non-terrestrial network.

At step 252, the high-power amplifiers (HPAs) associated with satellite-ground communications are set to off. In embodiments, the HPAs enter a reduced power or lower power state in order to conserve power, especially power stored on the satellite in one or more batteries. Affected HPAs may include one or more HPAs on board the satellite for transmission to UEs on the ground or to a ground station, one or more HPAs on board the satellite for receiving signals from the UEs or the ground station, and one or more HPAs for transmitted from the satellite to the ground station. The HPAs may be directed to enter the OFF state using a designated information element or parameter set by the gateway and transmitted on the uplink from the ground station to the satellite.

At step 254, a delay timer is started. The duration of the delay timer may be dynamically set to any suitable value. The delay timer is used to determine a maximum duration for keeping the HPAs in the OFF state. The delay timer duration may correspond to or be related to the delay threshold value set for the μDTX system and method. In an example, when the age of the oldest packet received and stored at the gateway has reached the delay threshold value (measured, for example, by a time stamp value), the delay timer may expire. At step 256, the delay timer is tested to see if it has expired.

If the delay timer has not expired, the method 250 includes a step 258 of receiving packets. The packets may include any sort of data including HTML data, VoIP data, etc. The packets generally include a header and a payload. The packets may be received from any source in the network or from another network, intended for a UE identified as a recipient who is being or will be in a service area served by the satellite in the near future. In embodiments, when packets are received, they are stored with an associated timestamp identifying the time of receipt. The timestamp information may be used to determine when the delay time should be set to expire or when the buffer should be cleared by transmitting all data to the satellite.

At step 260, packets are classified. Any suitable classification may be used including for example, deep packet inspection. IP packet priority may be marked in the IP packet header. If packet classification determines that one or more packets has a high priority, the packets may be mapped to a high priority QCI value for higher-priority treatment. For example, if the priority value indicates that the packet should be set immediately, the buffer may be cleared immediately and all buffered data transmitted to the satellite.

At step 262, a packet delay budget is computed. Any suitable computation or determination may be used, including the relation

dᵢ(t)=PBDᵢ−W_{i,t}

where PBDᵢ is the PDB of packet i and W_{i,t} is the packet delay of packet i at time t. In this example, dᵢ(t) is the remaining time of the packet delay to approach its PDB. The packet delay budget is used to dynamically determine the delay threshold or the maximum time delay before a transmission must occur.

At step 264, the method 250 determines if a physical resource block (PRB) threshold has been met or exceeded. In general, the μDTX system and method aim to deliver data PRBs in one or few time slots. μDTX will deliver a group of data when, for a group of received packets, the summation of the combined PRBs for the received packets has reached a value equal to or exceeding the value of PRB_threshold. The value may be set dynamically based on traffic volumes, types of traffic, etc. Any suitable value for PRB_threshold may be selected. In one example, the μDTX system and method may select PRB_threshold=Max. Allowed. PRB/TimeSlot. In another example, a percentage or other portion of the maximum allowed PRB per time slot may be selected, such as PRB_threshold=90% Max. Allowed PRB/TimeSlot.

If the PRB threshold value has not been reached, control returns to step 256 to determine if the delay timer has expired. The μDTX system and method may continue operation in a loop, receiving and classifying packets and determining the PDB, until either the delay timer expires, indicating that that the oldest packet that has been buffered reaches Delay_threshold, or until the PRB threshold is exceeded. As a third possibility, if time-sensitive packet arrives at the queue and it must be delivered right away, or with a very short delay, with all the buffered packets, the μDTX system and method will exit the loop.

If the delay timer has expired at step 256 or the PRB threshold has been exceeded, or a high priority packet has been received, at step 266, the HPAs are set to an ON condition. This corresponds to a powered-up condition in which the HPAs are enabled for communication of data. A predetermined time delay may be set to allow time for the high-power amplifiers to key up and reach stable operation. The HPAs may be directed to enter the ON state using a designated information element or parameter set by the gateway and transmitted on the uplink from the ground station to the satellite. At step 268, the currently buffered packets are transmitted from the terrestrial gateway to the satellite or constellation of satellites.

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 2D is a block diagram illustrating an example, non-limiting embodiment of a system 270 functioning within the communication network of FIG. 1 in accordance with various aspects described herein. The system 270 includes one or more gateways such as gateway 220 in communication with one or more ground stations such as ground station 222. The ground station 222 provides radio communication to one or more satellites such as satellite 272. In embodiments, the system 270 may be combined with aspects of the system 200 illustrated in FIG. 2A. For example, the system 270 may implement a non-terrestrial network such as satellite network 204. Moreover, the gateway 220 may communicate with one or more network elements of a terrestrial network such as cellular network 202.

As satellite to UE communications become more common, the network operator will need additional capacity in the network and additional coverage. Providing such capacity and coverage will create a need for traffic management in the network, including traffic management to offload traffic from one site to another.

In the example of FIG. 2D, the satellite 272 employs three different carriers labelled carrier 1, carrier 2 and carrier 3. Each of the three different carriers operates on a different frequency or frequency band to limit interference. Each carrier has its own respective high-power amplifier (HPA) labelled HPA1 for carrier 1, HPA2 for carrier 2 and HPA 3 for carrier 3. Each carrier serves a coverage service area labelled coverage area 274, coverage area 276 and coverage area 278. Three carriers is intended to be exemplary only. Any suitable number of carriers may be used by a satellite.

Thus, in some embodiments, as illustrated in FIG. 2D, wireless operators may use multi-carrier 5G-NTN Satellite Cells to provide capacity and coverage to terrestrial UEs such as UE 228, as indicated in FIG. 2D. Depending on the embodiment, these carriers may use the same frequency band (Intra-band) or different frequency band (Inter-band). Some of these carriers may support μDTX and may have different μDTX settings.

Moreover, each carrier may have different power saving goals and constraints. In addition, terrestrial UE traffic also may have different traffic profiles, such as VoIP, HTTP and first responders. Multiple consecutive high priority data packets may not allow one or all the carriers of the Satellite Cell to enter μDTX mode. For example, if an emergency is under way in the coverage area 274, the coverage area 276 and the coverage area 278, the high-priority first responder communications may prevent entry into μDTX mode. Even if the high priority data flow volume is low, it may be enough to prevent the satellite cell to enter μDTX mode.

To address this problem, the respective carriers of the satellite 272 may be used for different populations of users or UEs. The μDTX system and method can choose multiple sets of carriers based on UE packet delay requirements (i.e. low-delay, medium-delay, large-delay). The number of carriers in each set may depend, for example, on the traffic volume in each delay category, and the available resources in each carrier. The μDTX settings in each carrier set of the satellite 272 may be different. For example, carriers that handle packets with stringent delay requirements should also have stringent μDTX settings, or have μDTX disabled. On the other hand, carriers that handle packets with relaxed delay requirements should also have relaxed μDTX settings. Such relaxed μDTX settings which will yield to larger HPA power saving periods. Embodiments of the μDTX system and method may mandate each carrier to follow different μDTX schedules. During the OFF-Cycle of each carrier, the corresponding HPA should be powered OFF to preserve energy. Note that, the Forward link Terrestrial to Satellite should stay up while at least of the carriers is transmitting. Further, the terrestrial gateway 220 communicates the μDTX schedule to the satellite cell in real-time while Forward link Terrestrial to Satellite is up. The μDTX configuration at the carrier level can be updated in real-time, if required.

So, similar to the embodiments discussed above, the μDTX system and method may be located in any suitable network element. In general, the gateway 220 has access to information required to implement μDTX features.

As packets are received at the gateway 220, packet classification should be performed at the gateway 220. As discussed, such packet classification can be done by means of Deep Packet Inspection (DPI) techniques, or similar, which can read the header of IP-Packets to identify the corresponding DSCP marking. Similarly, DPI can identify the application type (i.e. HTTP, P2P) and infer the corresponding delay requirements for the individual packet.

Once the packets are classified, they packets can be grouped according to any suitable classification or features. For example, the μDTX system and method may select and group together a set of carriers of the satellite 272, such as carrier 1, that should only handle packets with stringent delay requirements, such as VoIP packets. Those stringent requirement, low-delay packets can be designated for carrier 1 and collected in a buffer. Thereafter, the rules for determining a delay threshold and a PRB threshold discussed above may be implemented for packets assigned to carrier 1. Further, a second set of carriers, such as carrier 2, is selected to only handle packets with relaxed delay requirements, such as HTTP packets. These relaxed delay packets can be collected together in a common buffer associated with carrier 2. Again, the same procedures for determining delay threshold and PRB threshold may be applied to the packets in the buffer associated with carrier 2. It can be expected, for example, that the second set of carriers may be able to achieve higher HPA power savings compared to the first set of carriers since the second set of carriers, associated with carrier 2, may use longer delay times before transmitting, meaning that the HPA will be powered OFF for a longer time.

For example, the μDTX method and system can choose a set of carriers that should only handle packets with stringent delay requirements (i.e. VoIP), and a second set of carriers that should only handle packets with relaxed delay requirements (i.e. HTTP). It can be expected that the second set of carriers may be able to achieve higher HPA power savings compared to the first set of carriers.

In embodiments, the μDTX system and method can select a target carrier from a plurality of carriers, such as carrier 1, carrier 2 and carrier 3. These may be referred to as μDTX carrier groups. Each μDTX carrier group, carrier 1, carrier 2 and carrier 3 in this example, may correspond to or define a number of different physical carrier frequencies or bands. Assignment of any particular physical carrier frequency or band to a μDTX carrier group may be done dynamically on an as needed basis, dictated by traffic volume, traffic type, etc. The carriers may have different μDTX settings. In addition, a plurality of terrestrial UEs may be capable to select one or more of carriers as HO target carrier.

Once packets are categorized and sorted according to some feature, the gateway 220 or other network element may forward data packets based on their delay requirements to a corresponding carrier or μDTX carrier group of the satellite cell.

The μDTX method and system may apply traffic management techniques to the UEs in the given area to force UEs to perform handover or Idle Mode Cell Reselection to the corresponding cell. This may be done based on traffic type or UE type, for example, to combine traffic types, UE types or any categorization, together for power efficient service by a single carrier or μDTX carrier group.

In embodiments, the μDTX system and method constantly monitor many performance factors for the system 270. One factor is the utilization of the carriers in each set or each μDTX carrier group. If traffic of a category that is assigned to a particular carrier group is increasing, for example, additional physical carriers may be assigned to the μDTX carrier group.

Another factor to be monitored is the amount or time of HPA power saving experience for each μDTX carrier group. For example, the μDTX carrier group selected to handle high priority, first responder communications may find its battery level depleting more rapidly compared to another μDTX carrier group. The μDTX carrier group assignments may be varied subsequently to route less usage-intensive packets to the depleted μDTX carrier group.

Another factor to be monitored is the UE Quality of Experience (QoE) of a user. In the example, types or categories of traffic assigned to different carriers may be varied in order to equal out QoE performance indicators for users.

Another factor to be monitored is reported satellite cell battery power for individual carrier batteries. In this example, each separate carrier on the satellite 272 has a respective HPA and also a respective battery. Normal operation of the satellite 272 includes reporting battery condition information such as a state of charge for each respective battery. In an example, the state of charge may be compared with a depletion threshold. If the state of charge falls below the depletion threshold, batteries and carriers may be reassigned. Thus, if one battery is relatively depleted due to handling high-priority traffic by its respective carrier, such as VoIP, packet assignments may be distributed to other carriers associated with other, less depleted batteries and lower priority traffic may be assigned to the depleted battery and its associated carrier. This may continue until the battery depletion is reduced or the battery's state of charge increases above a recharge threshold.

These factors can be used by the μDTX method and system to further optimize the system aiming to accomplish energy saving based on μDTX mode, while assuring that flow and UE delay requirements are met.

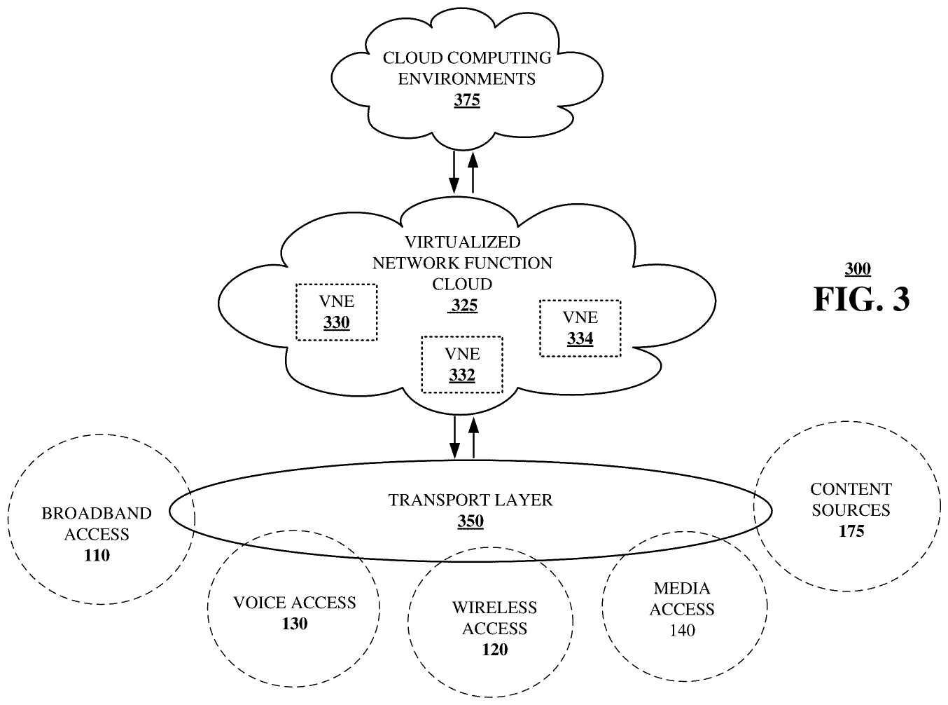

Referring now to FIG. 3, a block diagram is shown illustrating an example, non-limiting embodiment of a virtualized communication network in accordance with various aspects described herein. In particular a virtualized communication network 300 is presented that can be used to implement some or all of the subsystems and functions of system 100, the subsystems and functions of system 200, and method 230 presented in FIGS. 1, 2A, 2B, 2C, and 3. For example, virtualized communication network 300 can facilitate in whole or in part use of micro-discontinuous transmission (μDTX) to reduce power consumption in satellites of a non-terrestrial network that provides communication services to terrestrial user equipment by categorizing packets prior to transmission and transmitting only packets with similar delay requirements at a selected time.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

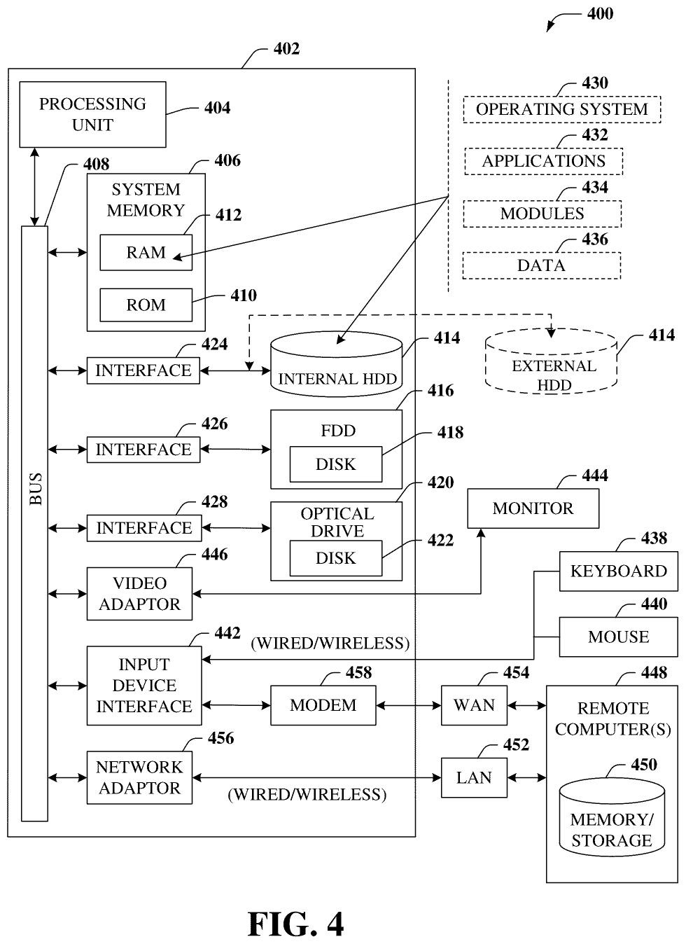

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part the use of micro-discontinuous transmission (μDTX) to reduce power consumption in satellites of a non-terrestrial network that provides communication services to terrestrial user equipment by categorizing packets prior to transmission and transmitting only packets with similar delay requirements at a selected time.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

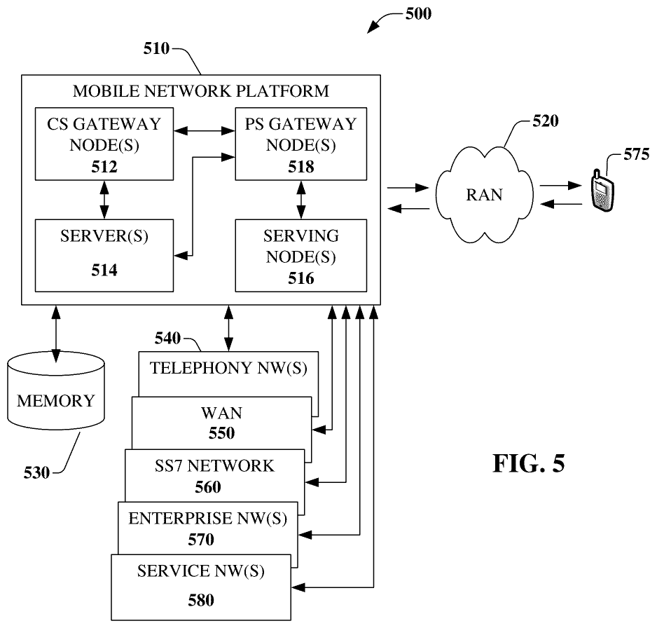

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part using micro-discontinuous transmission (μDTX) to reduce power consumption in satellites of a non-terrestrial network that provides communication services to terrestrial user equipment such as radio telephone 575 by categorizing packets prior to transmission and transmitting only packets with similar delay requirements at a selected time. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

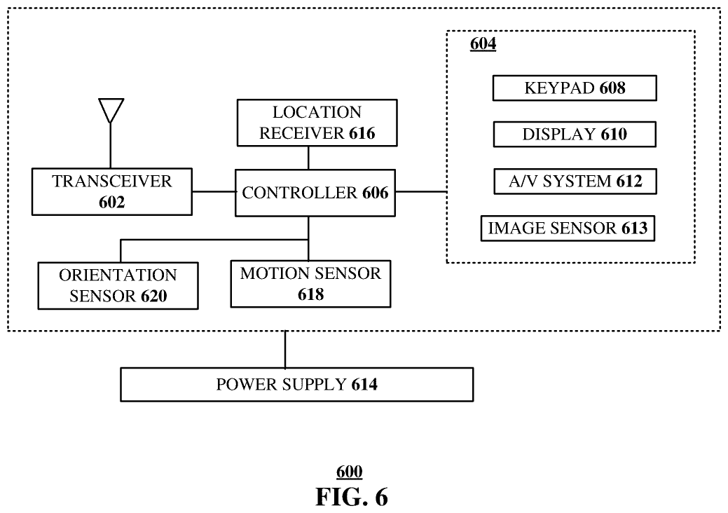

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part using micro-discontinuous transmission (μDTX) to reduce power consumption in satellites of a non-terrestrial network that provides communication services to terrestrial user equipment such as the communication device 600 by categorizing packets prior to transmission and transmitting only packets with similar delay requirements at a selected time.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data torage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure.

The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving packets at a network element associated with a non-terrestrial communications network;
classifying the packets according to a performance criterion, forming classified packets;
detecting occurrence of a predetermined transmission condition;
transmitting the classified packets to a satellite for retransmission from the satellite to a terrestrial user equipment; and
disabling a high-power amplifier (HPA) of the satellite following the transmitting the classified packets to the satellite to reduce power consumption in the satellite.

2. The device of claim 1, wherein the operations further comprise:
classifying the packets to identify an application type associated with the packets.

3. The device of claim 1, wherein the operations further comprise:
classifying the packets to determine delay requirements for the packets;
grouping classified packets according to common delay requirements, forming multiple delay groups of packets; and
transmitting an individual group of packets of the multiple delay groups of packets to the satellite.

4. The device of claim 1, wherein classifying the packets comprises:
classifying the packets based on deep packet inspection.

5. The device of claim 1, wherein the classifying the packets comprises:
determining a Differentiated Services Code Point (DSCP) code associated with a packet; and
classifying the packet according to the DSCP.

6. The device of claim 5, wherein the operations further comprise:
identifying the packet as having a high priority based on a DSCP value of the packet;
mapping the DSCP value of the packet to a Quality of Service Class Identifier (QCI) value; and
classifying the packet according to the QCI value.

7. The device of claim 1, wherein the operations further comprise:
determining a maximum packet delay for packets received at the network element;
determining a delay threshold based on the maximum packet delay;
timing a time duration from first receipt of a packet received at the network element; and
when the time duration matches the delay threshold, transmitting the packets received at the network element to the satellite.

8. The device of claim 7, wherein the determining a maximum packet delay comprises:
determining a transmission delay for the packets received at the network element for transmission from the network element to the satellite and for transmission from the satellite to the terrestrial user equipment.

9. The device of claim 1, wherein the operations further comprise:
comparing an amount of data received in the packets received at the network element with a threshold value; and
when the amount of data received in the packets received at the network element exceeds the threshold value, transmitting the classified packets to the satellite.

10. The device of claim 9, wherein the operations further comprise:
determining the threshold value as a percentage of a maximum allowed data to be transmitted to the satellite in a time slot.

11. A non-transitory machine-readable medium, comprising executable instructions that, when executed by a processing system including a processor, facilitate performance of operations, the operations comprising:
switching a high-power amplifier (HPA) of a satellite to an OFF State, wherein the switching comprises transmitting a command from a gateway to the satellite, the satellite operative for communication with terrestrial user equipment;
receiving packets at the gateway, wherein the receiving the packets comprises receiving data intended for communication to the terrestrial user equipment;
classifying the packets according to delay requirements for respective packets, wherein packets having similar delay requirements are classified together, forming groups of classified packets;
detecting an occurrence of a predetermined transmission condition for the satellite;
switching the HPA of the satellite to an operating power state to enable full radio operation of the satellite;
transmitting the groups of classified packets to the satellite for retransmission from the satellite to the terrestrial user equipment, wherein the transmitting the groups of classified packets is according to delay requirements of packet of the groups of classified packets; and
after the transmitting the groups of classified packets, switching the HPA of the satellite to the OFF State to conserve power at the satellite.

12. The non-transitory machine-readable medium of claim 11, wherein the classifying the packets comprises:
using deep packet inspection on the packet to determine a Differentiated Services Code Point (DSCP) code associated with a packet;
classifying the packet according to the DSCP code; and
grouping packets according to the DSCP code.

13. The non-transitory machine-readable medium of claim 11, wherein the classifying the packets comprises:
using deep packet inspection on the packet to determine an application type associated with the packet;
inferring a delay requirement for the packet based on the application type associated with the packet; and
grouping packets according to inferred delay requirements.

14. The non-transitory machine-readable medium of claim 11, wherein the detecting the occurrence of a predetermined transmission condition for the satellite comprises:
determining a delay threshold for the groups of classified packets
determining a data threshold for the groups of classified packets;
determining ages of respective packets based on timestamp information for the respective packets;
determining data size of the respective packets; and
identifying the predetermined transmission condition based on an age of a selected packet exceeding the delay threshold or an accumulated size of the groups of classified packets exceeding the data threshold.

15. The non-transitory machine-readable medium of claim 11, wherein the switching the HPA of the satellite to the OFF State comprises:
switching the HPA of the satellite to the OFF State to conserve power at the satellite, wherein a duration of the OFF State correlates with an amount of power conserved at the satellite.

16. A method, comprising:
receiving, by a processing system including a processor, packets at a network element associated with a non-terrestrial communications network, the packets for communication to respective terrestrial user equipment by a satellite, the satellite employing multiple respective carriers for radio communication with terrestrial user equipment, each respective carrier of the multiple respective carriers being communicated using a respective high power amplifier (HPA), each respective HPA being maintained in an OFF state when not used for communication;
classifying, by the processing system, the packets according to delay requirements for respective packets, wherein packets having similar delay requirements are classified together, forming groups of classified packets;
selecting, by the processing system, a respective carrier of the multiple respective carriers for communicating a group of classified packets, forming a selected carrier;
switching the respective HPA of the satellite associated with the selected carrier to an ON state to enable radio communication by the selected carrier;
transmitting the group of classified packets to the satellite for retransmission from the satellite to the terrestrial user equipment on the selected carrier; and
after the transmitting the group of classified packets, switching the respective HPA of the satellite to the OFF state to conserve power at the satellite.

17. The method of claim 16, further comprising:
designating, by the processing system, a respective carrier of the multiple respective carriers for communicating groups of classified packets having a highest priority based on a stringent delay requirement of packets of the groups of classified packets, forming a high-priority carrier; and
communicating, by the processing system, all packets having the highest priority to the satellite for retransmission from the satellite to the terrestrial user equipment on the high-priority carrier.

18. The method of claim 16, further comprising:
designating, by the processing system, a second respective carrier of the multiple respective carriers for communicating groups of classified packets having a relaxed delay requirement, forming a low-priority carrier; and
communicating, by the processing system, all groups of packets having the relaxed delay requirement to the satellite for retransmission from the satellite to the terrestrial user equipment on the low-priority carrier.

19. The method of claim 16, further comprising:
assigning, by the processing system, a respective priority for each respective HPA, wherein the respective priority for each respective HPA is related to delay requirements for respective packets associated with the respective HPA;
maintaining, by the processing system, the each respective HPA in the OFF state for a respective OFF duration, wherein the respective OFF duration is longer for a respective HPA having a lower priority to improve power conservation at the satellite.

20. The method of claim 16, further comprising:
determining, by the processing system, packet delay requirements for the respective packets; and
designating, by the processing system, one or more respective carriers of the multiple respective carriers based on the packet delay requirements so that respective packets having a similar packet delay requirement are designated for communication on a same designated carrier.
